(19) United States
(12) Patent Application Publication
(10) Pub. No.: US 2004/0198360 A1
(43) Pub. Date: Oct. 7, 2004

(54) Subscriber device selection of service provider network based on predicted network capabilities

(75) Inventor: Michael D. Kotzin, Buffalo Grove, IL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/208,970

(22) Filed: Jul. 31, 2002

(51) Int. Cl. H04Q 7/20

(52) U.S. Cl. 455/445; 455/432.1; 455/435.1

(57) ABSTRACT

Selection of a service provider network at a wireless subscriber device (10) includes monitoring service provider network parameters (54) of each of a plurality of available service provider networks (S1, S2), predicting performance capabilities of each of the plurality of available service provider networks (S1, S2), computing a performance metric (56) for each of the plurality of available service provider networks (S1, S2) based on desired performance parameters and on the predicting of performance capabilities of each of the plurality of available service provider networks (S1, S2), and selecting one of the plurality of available service provider networks (S1, S2) based on the computed performance metric (58). The subscriber device (10) is therefore capable of rapidly and autonomously identifying a service provider network that would best serve its current service needs based on the performance metric.

### BACKGROUND OF THE INVENTION

1. Field of the Invention

The present invention relates to wireless communications, and specifically to a wireless network subscriber device that is capable of rapidly and autonomously identifying and selecting a network service provider that is best suited to meet its current service needs.

2. Description of Related Art

A wireless communications device such as a cellular subscriber device (subscriber device) connects to a wireless network of a service provider using a standardized air interface technology, such as IS-95 or GSM. The service provider in turn provides communications services to the subscriber unit, such as voice, circuit data or packet data transmission services, and enables the subscriber device to connect to the publicly switched telephone network (PSTN) or data networks as is well known in the art.

Conventionally, a subscriber device user subscribes to a single wireless network service provider and utilizes that network service provider exclusively to provide communications services to the subscriber device. Therefore, the network service provider often provides these communications services without any regard for the type of data, the associated data transmission requirements, or the ability of the subscriber device or the network service provider itself to meet a given quality of service at a given cost. As a result, communications sessions are limited by the performance capabilities of the network service provider. For example, if the subscriber device user desires to establish a communications session to transmit a data message and the subscribed-to service provider network is heavily loaded, the subscriber device user is nonetheless relegated to transmitting the data message over the subscribed-to service provider network even though the available data rate is slower than that of other available service provider networks.

It is also known for a subscriber to have access to a plurality of wireless service providers. In this case, a conventional subscriber device may be able to make simple decisions about which network service provider to use based on cost of services or signal strength capabilities. For example, the subscriber device might simply opt to use the wireless service provider that has the strongest signal strength. Alternatively, the subscriber device might negotiate through protocol signaling sequentially with the plurality of wireless service providers and make a decision on which provider to use based on tariff or quality of service that the network might be able to provide. In the latter case, the network service provider infrastructure might exploit simple or complicated decision making in response to subscriber device processing requests. In any case, the subscriber device is limited in its ability to make assessments by the ability of the wireless service provider to support its requirements because the subscriber device must rely on information provided by the wireless service provider. Therefore, a subscriber device has limited flexibility in adapting to real time performance needs and making more refined decisions on which service provider to use.

Therefore, what is needed is a subscriber device that is capable of rapidly and autonomously identifying a network service provider that might better serve its current service needs and meet a higher performance level.

### BRIEF DESCRIPTION OF THE DRAWINGS

Objects and advantages of the present invention will be more readily apparent from the following detailed description of preferred embodiments thereof when taken together with the accompanying drawings in which:

FIG. 1 is a block diagram of a subscriber device according to a preferred embodiment of the present invention;

FIG. 2 is a system diagram showing the subscriber device of FIG. 1 and two available service provider networks;

FIG. 3 is a flow diagram illustrating the selection methodology utilized by the subscriber device of FIG. 1 in selecting a service provider network.

### DETAILED DESCRIPTION OF THE PRESENTLY PREFERRED EXEMPLARY EMBODIMENTS

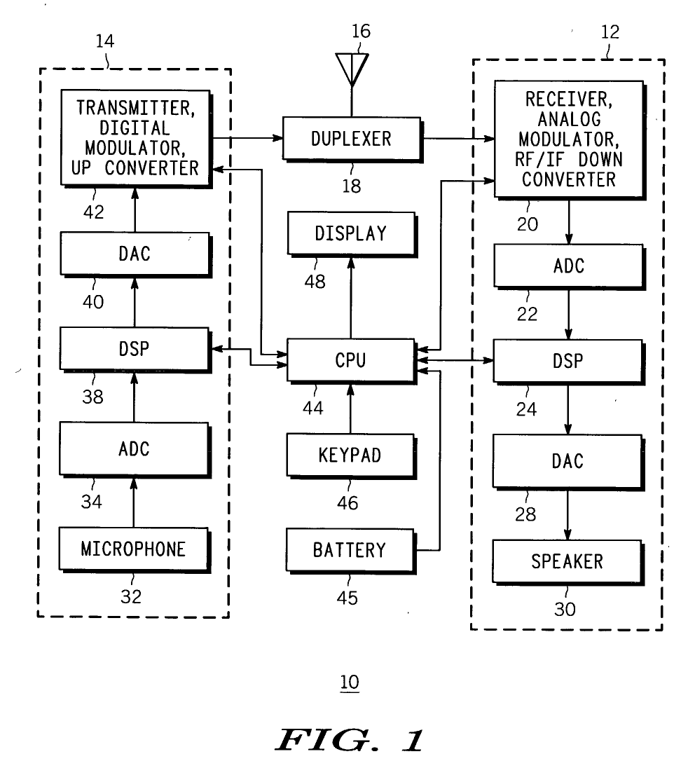

Referring now to the drawings in which like numerals reference like parts, FIG. 1 shows the components of a wireless subscriber device (subscriber device) 10 according to the present invention. The subscriber device 10 is a cellular telephone programmed to communicate across a wireless air-interface through an IS-95 Code Division Multiple Access (CDMA) communications protocol. However, the subscriber device 10 may be any type of wireless subscriber device such as, for example, GSM, GPRS, EDGE, TETRA, iDEN, W-CDMA, or CDMA2000.

The subscriber device 10 may be of a generally known construction and one that exploits commercially available CDMA chip sets. Specifically, a receiver block 12 and a transmitter block 14 are each coupled to an antenna 16 through an antenna duplexer 18. A receiver/analog demodulator/RF/IF downconverter (receiver) 20 is responsible for demodulating all the information that it receives from cellular infrastructure equipment. This includes data signaling as well as speech or data traffic. In addition to demodulating information, the receiver 20 may provide some additional information, such as, for example, signal strength or other quality metrics, about the received signal that are known to be used for call and system control, including signaling back information to the cellular infrastructure to enable power control, and handover.

In addition, the receiver block 12 also includes additional components such as an A/D converter 22 for converting the demodulated RF signal to a digital signal, a digital signal processor 24 for further decoding and processing of the digital signal, and a digital to analog converter 28 for converting the digital signal back to an analog signal that is output to a speaker 30. As these additional components are all of the type well known in the art and are discussed generally only to provide a contextual setting for the present invention, further discussion is not necessary.

The transmitter block 14 receives an input analog speech signal through an input device such as a microphone 32 and converts the information to a digital signal through an analog to digital converter 34. A digital signal processor 38 processes and encodes the digital signal, and the digital signal is then converted back to an analog signal by a digital to analog converter 40 before being processed for transmission by a transmitter/digital modulator/upconverter (transmitter) 42. As these components of the transmitter block 14 are all of the type well known in the art and are discussed generally only to provide a contextual setting for the present invention, further discussion is not necessary.

The above-discussed components of the receiver and transmitter blocks 12, 14 are controlled by a central processing unit (CPU) 44, such as a Motorola M-CORE microprocessor. The CPU 44 controls all functions of the receiver block 12 and the transmitter block 14 within the subscriber device 10, including the instantaneous operating frequency being received and transmitted upon (possible through synthesizer control signals from the CPU 44 to the receiver 20 and the transmitter 42, respectively), and the creation and deciphering of control signaling messages to allow for proper call processing (possible through control signals and data from the CPU 44 to the DSPs 24, 38, respectively). The CPU 44 in turn is powered by a conventional subscriber device battery 45 and is responsive to data input by a subscriber device user through an input device such as a keypad 46 and displayed on a device display 48. Other data devices, such as a computer, might be coupled to the CPU 44 so that it could communicate with the infrastructure via the subscriber device 10. A multitude of possible transceiver structures and modifications are well known in the art, including for example, the use of a single synthesizer to control the transmitter and receiver frequencies.

The operation of a conventional subscriber device is likewise well known. Generally, a CPU controls a frequency synthesizer so that a receiver is able to demodulate broadcast information from the control channel of a particular service provider. The service provider might be selected from a list of typical frequencies to which a user might have subscribed. The subscriber device might scan several different frequencies to find the strongest such control channel from that particular service provider. When the subscriber device finds the best signal, it will idle on that channel and decode downlink messages, ultimately waiting for a paging signal indicating arrival of a call.

If a subscriber desires to make a call or establish a data communications session, it will make an uplink request on the access control channel. Before establishing the uplink communication, the subscriber device may scan and searche again to find the strongest link from a given first service provider network. Alternatively, the subscriber device may establish a communication with one or more service providers, negotiating for a quality of service or low tariff for the prospective communication it desires to make.

In the subscriber device 10 of the present invention, the CPU 44 is programmed further to autonomously predict the performance capabilities of available service provider networks and to select a service provider network to provide wireless communications services in a manner that will be discussed below in more detail. For purposes of discussion, data input through the keypad 46 will be referred to throughout as communications session commands.

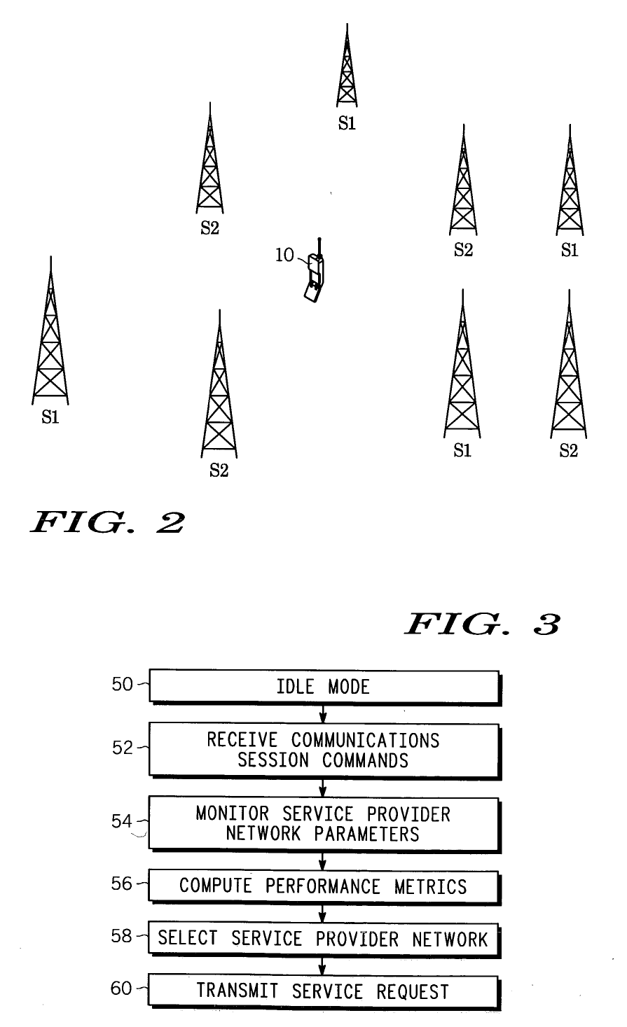

Operation of the subscriber device 10 will now be discussed with reference to FIGS. 1-3. In FIG. 2, the subscriber device 10 is shown as being located in the service areas of two service provider networks S1, S2, with base stations representing the general infrastructure of each of the service providers S1, S2. Although only two service provider networks S1, S2 are shown, the subscriber device of the present invention is capable of computing performance metrics for any number of available service provider networks.

In FIG. 3, at 50 the subscriber device 10 remains in an idle mode until at 52 it receives communications session commands input through the keypad 46. In response, at 54, the subscriber device 10 begins to monitor service provider network parameters of each of the service provider networks S1, S2.

Subsequently, at 56 the CPU 44 computes a performance metric for each of the service provider networks S1, S2 to determine which of the two is best suited to meet its current service needs. The performance metric is based on more than a simple signal strength or quality of reception metric. The metric is based on, for example, additional indicia that give the subscriber additional information about the likelihood of a successful communication, the likelihood of obtaining a low cost service, the ability to minimize the use of expended transmitted power, and/or the ability to obtain a signal that will continue to provide a high degree of performance.

One of the performance metrics might include an assessment of the loading of the service provider networks S1, S2. This could be predicted by the subscriber device 10 sequentially monitoring and measuring the number of active downlinks that each of the service provider networks S1, S2 has in service. In a CDMA system, one simple way of determining this is to monitor the downlink and for the subscriber to attempt to demodulate each of the possible Walsh encodeings present on the downlink carrier. A count will indicate the number of assigned channels and therefore subscribers being serviced which relates to system loading.

Another of the performance metrics might include an assessment of how much transmitted power is needed by the subscriber device 10 to communicate with a particular service provider. The more transmitter power that is required, the higher a subscriber's power consumption will be and the shorter will be its battery lifetime.

The subscriber device 10 might attempt to demodulate all the downlink control channels from the various sites (or sectors) of the service provider networks S1, S2. In this way, the subscriber device might estimate the degree of coverage that a service provider might offer over a period of time.

It is understood that many of the measurements might be somewhat perishable and have only a limited lifetime, and that the subscriber device 10 might continue to make the assessments and change the operator being used over a period of time depending on its communication requirements. It is also understood that some of the assessments made by the subscriber device 10 might provide information about the likelihood of a particular service provider's ability to continue to provide acceptable service.

The subscriber device 10 might further perform processing that a conventional subscriber device is known to perform. This includes, for example, finding the strongest signal from either of the service provider networks S1, S2, or negotiating for service (with respect to quality of service provisions or cost). This information might be combined with the unique measurements to provide a composite metric that allows an objective assessment of each of the service provider networks S1, S2.

The CPU 44 computes a performance metric for each of the service provider networks S1, S2 based on performance parameters desired by the subscriber device user and on the predicted performance capabilities of the subscriber device and of each of the service provider networks S1, S2. More specifically, the CPU 44 computes a composite performance metric for each of the service provider networks S1, S2 by using an algorithm that assigns predetermined weighting coefficients to the performance parameters measured or determined by the subscriber device user and to the predicted performance capabilities of the subscriber device 10 and of each of the service provider networks S1, S2 to determine which of the service provider networks S1, S2 is best suited to meet the service requirements of the subscriber device 10. The subscriber device 10 is then able to engage communication with the most desired service provider.

The above technique might be performed before engaging in any mobile originated communication such as, for example, carriage of voice, short packet data, long data packets, or circuit switched data. The exact algorithm of obtaining the composite metric might be different for each particular case. Performance parameters, which might be characterized by a particular set of weighting coefficients desired by the subscriber device 10, may be pre-programmed into the CPU 44 and/or be based on subscriber device subscription parameters such as, for example, a pre-negotiated tariff, particularly if the tariff is not able to be negotiated dynamically and in real time before the onset of a particular communication exchange. Exemplary performance parameters include desired data mode of operation (voice/data), desired quality of service, desired cost of service, desired signal strength, channel quality, system loading, amount of transmitter power required, predicted density/number of base station and or sector cells, or the determined location of base sites (often obtainable from a base site's transmitted downlink broadcast message). Alternatively, the subscriber device 10 may receive performance parameters that are manually entered through the keypad 46, for example, in response to prompts that automatically appear on the display 48 upon initiation of a communications session, or in response to prompts that appear in response to input data indicating that the subscriber device user wishes to enter such parameters. For example, if communications session commands are entered via the keypad 46, the CPU 44 may in response generate a VOICE OR DATA? prompt on the display 46 that may require the subscriber device user to key in a V response for voice service or a D response for data service. The CPU 44 then uses the keyed in response in computing a performance metric for each of the service provider networks S1, S2.

In summary, the subscriber device 10 predicts the performance capabilities of each of the service provider networks S1, S2 based on its monitoring of service provider network parameters for each of the service provider networks S1, S2. Specifically, the receiver 20 monitors or determines and provides to the CPU 44 information on, for example, network loading, network throughput, allocated network codes, quality of service, network performance, network reliability, distance to network, communication power requirements, density of base site cells, and/or the number of sectors for base sites for each of the service provider networks S1, S2 by monitoring signals transmitted by network components of the service provider networks S1, S2 indicative of the above exemplary network parameters, or by engaging in brief probing communication with each of the different service provider networks S1, S2.

Referring back to FIG. 3, at 58, once the CPU 44 computes the performance metric for each of the service provider networks S1, S2 based on performance parameters desired by the subscriber device user and on the predicted performance capabilities of the subscriber device 10 and of each of the service provider networks S1, S2, it selects one of the service provider networks S1, S2 based on an evaluation of the computed performance metrics. For example, if subscriber performance parameters indicate that a voice communications session is to be initiated and that likelihood of continued service is a critical issue, the service provider network S1 may be chosen if the CPU 44 determines that the service provider network S2, is heavily loaded, and will be less likely to continue to provide a high degree of service to the subscriber device 10. In another example, the subscriber device 10 might determine that the density of cells in the area for service provider network S2 is significantly higher than the service provider network S1. The subscriber device 10 might pick the service provider network S1 based on the conclusion that its ability to maintain continue service will be more likely as it moves about the local area. However, if subscriber performance parameters indicate that a data communications session is to be initiated, and if predicted subscriber device performance capabilities indicate that remaining life of the battery 45 of the subscriber device 10 is low, the CPU 44 may select the service provider network S2 if it determines that the service provider network S2 is closer in proximity to the subscriber device 10 and therefore would require the subscriber device 10 to use less power in establishing a communications session than would the service provider network S1. This selection might be made even if the service provider network S2 is a more costly network to use.

At 60, once the CPU 44 selects the one of the available service provider networks S1, S2 based on an evaluation of the computed performance metrics, the CPU 44 instructs the transmitter block 14 to transmit a service request to the selected one of the available service provider networks S1, S2 to initiate a communications session. The communications session then proceeds according to conventional CDMA protocol.

As should be appreciated from the foregoing description, the subscriber device 10, and more specifically the CPU 44, of the present invention is capable of rapidly and autonomously identifying, making the desired measurements and determinations, possibly probing each of the available service providers, and selecting a network service provider that is best suited to meet its current service needs. The subscriber device 10 is able to identify and select such a service provider network because it is able to predict, through computation and comparison of a performance metric for each of the service provider networks, the performance capabilities of the service provider networks. The subscriber device 10 is also capable of selecting and identifying such a service provider network by factoring in performance parameters desired by the subscriber device user and predicted performance capabilities of the subscriber device to determine which of the service provider networks S1, S2 is best suited to meet the service requirements of the subscriber device 10. As a result, a subscriber device user gains more control over the type and quality of wireless services provided to the subscriber device 10 during a communications session.

While the above description is of the preferred embodiment of the present invention, it should be appreciated that the invention may be modified, altered, or varied without deviating from the scope and fair meaning of the following claims.

For example, re-calculation of performance metrics can be initiated when, for example, movement of a subscriber device relative to a service provider network so dictates, or when performance capabilities of an engaged service provider network or the performance parameters of the subscriber device 10 change during a communications session. This might or might not be done in conjunction with the servicing service provider network. For example, the subscriber device 10, with its measurement and demodulating capability to measure neighbors, might continue to make loading assessments, etc. In addition, although the CPU 44 has been described as computing a performance metric for each of the service provider networks S1, S2 based on performance parameters desired by the subscriber device user and on the predicted performance capabilities of the subscriber device 10 and of each of the service provider networks S1, S2, the CPU 44 may be programmed to compute a performance metric for each of the service provider networks S1, S2 based on only one or two of the following: performance parameters desired by the subscriber device user; predicted performance capabilities of the subscriber device; and predicted performance capabilities of each of the service provider networks S1, S2.

What is claimed is:

1. A method of selecting a service provider network at a wireless subscriber device comprising:
monitoring service provider network parameters of each of a plurality of available service provider networks;
predicting performance capabilities of each of the plurality of available service provider networks;
computing a performance metric for each of the plurality of available service provider networks based on desired performance parameters and on the predicting of performance capabilities of each of the plurality of available service provider networks; and
selecting one of the plurality of available service provider networks based at least in part on the computing of the performance metric.

2. The method of claim 1, wherein the monitoring of service provider network parameters of each of a plurality of available service provider networks comprises monitoring one or more of network loading, network throughput, allocated network codes, cost of service, quality of service, network performance, network reliability, distance to network, and communication power requirements.

3. The method of claim 1, further comprising transmitting a service request to the one of the plurality of available service provider networks.

4. The method of claim 1, further comprising remaining in a default idle mode during periods of non-communication; and
wherein the monitoring of service provider network parameters of a plurality of available service provider networks is initiated only when a communications session is initiated.

5. The method of claim 1, wherein the computing of a performance metric for each of the plurality of available service provider networks based on desired performance parameters and on the predicting of performance capabilities of each of the plurality of available service provider networks comprises computing a performance metric based on user-input desired performance parameters and on the predicting of performance capabilities of each of the plurality of available service provider networks.

6. The method of claim 1, wherein the computing of a performance metric for each of the plurality of available service provider networks based on desired performance parameters and on the predicting of performance capabilities of each of the plurality of available service provider networks comprises computing a performance metric based on pre-programmed desired performance parameters and on the predicting of performance capabilities of each of the plurality of available service provider networks.

7. The method of claim 1, wherein the computing a performance metric for each of the plurality of available service provider networks based on desired performance parameters and on the predicting of performance capabilities of each of the plurality of available service provider networks comprises computing a performance metric based on one or more of the following: requirements of a communications session to be initiated; subscriber device operating capabilities; current session handling capabilities of each of the plurality of available service provider networks; and a subscriber device subscription profile.

8. The method of claim 1, further comprising:
predicting subscriber device performance capabilities; and
computing the performance metric for each of the plurality of available service provider networks based on desired performance parameters, on the predicting of performance capabilities of each of the plurality of available service provider networks, and on the predicting of subscriber device performance capabilities.

9. The method of claim 1, further comprising re-computing the performance metric for each of the plurality of available service provider networks based on the desired performance parameters and on the predicting of performance capabilities of each of the plurality of available service provider networks based on one of subscriber device movement relative to an engaged service provider network and a change in performance capabilities of the engaged service provider network.

10. The method of claim 1, wherein the monitoring of service provider network parameters of each of a plurality of available service provider networks comprises engaging in brief probing communication with each of the plurality of available service provider networks.

11. A mobile subscriber device comprising:
a receiver for monitoring service provider network parameters;
a processor in communication with the receiver for predicting performance capabilities of each of a plurality of available service provider networks based on the service provider network parameters, for computing a performance metric for each of a plurality of available service provider networks based on desired performance parameters, and for selecting one of the plurality of available service provider networks based on its associated performance metric; and
a transmitter for transmitting a request to a service provider network selected by the processor as being capable of currently providing services based on the performance metric.

12. The mobile subscriber device of claim 11, wherein the service provider network parameters comprise one or more of network loading, network throughput, allocated network codes, cost of service, quality of service, network performance, network reliability, distance to network and network power requirements.

13. The mobile subscriber device of claim 11, wherein the receiver is for monitoring the network loading parameters by monitoring one or more of allocated network codes and network power levels.

14. The mobile subscriber device of claim 11, wherein the processor is further for computing the performance metric for each of the plurality of available service provider networks based in part on predicted subscriber device capabilities.

15. The mobile subscriber device of claim 14, wherein the subscriber device capabilities include at least one of estimated subscriber device battery life, required session data rate and a subscriber device subscription profile.

16. The mobile subscriber device of claim 11, wherein the receiver is for monitoring the service provider network parameters of a plurality of available service provider networks only when a subscriber device communications session is initiated.

17. The mobile subscriber device of claim 11, wherein the desired performance parameters are user-input performance parameters.

18. The mobile subscriber device of claim 11, wherein the desired performance parameters pre-programmed performance parameters.

19. The mobile subscriber device of claim 11, wherein the processor is for selecting the one of the plurality of available service provider networks based on the associated performance metric, the associated performance metric indicating that the one of the plurality of available service provider networks is most capable of providing services necessary for desired mobile subscriber device performance parameters.

20. A mobile subscriber device comprising:
means for monitoring service provider network parameters;
means for predicting performance capabilities of each of a plurality of available service provider networks based on the service provider network parameters, for computing a performance metric for each of a plurality of available service provider networks based on desired performance parameters, and for selecting one of the plurality of available service provider networks based on its associated performance metric; and
means for transmitting a request to a service provider network selected by the predicting means as being capable of currently providing services based on the performance metric.
